(19) United States
(12) Patent Application Publication
(10) Pub. No.: US 2016/0024705 A1
(43) Pub. Date: Jan. 28, 2016

(54) NON-CYLINDRICAL DAMPING ELEMENT SUSPENSION

(71) Applicant: Suspa GmbH, Altdorf (DE)

(72) Inventors: Tyler S. Hernden, Caledonia, MI (US); James L. Vander Zanden, Grand Haven, MI (US); D. Stuart Atwater, Grand Rapids, MI (US)

(73) Assignee: Suspa GmbH, Altorf (DE)

(21) Appl. No.: 14/773,814

(22) PCT Filed: Feb. 20, 2014
(86) PCT No.: PCT/US14/17340

§ 371 Date: Sep. 9, 2015

Related U.S. Application Data
(60) Provisional application No. 61/779,677, filed on Mar. 13, 2013.

(51) Int. Cl. D06F 37/24; F16F 13/00; F16F 7/08

(52) U.S. Cl. CPC D06F 37/24; F16F 7/08; F16F 13/005

(57) ABSTRACT

A damper includes a housing having a friction element receiving chamber for receiving a planar friction element, such as foam pads. The foam is injected with grease. Two rectangular greased foam pads are inserted into an open housing within a pad-receiving recess in the housing. A cap is then assembled onto the housing. The housing-foam-cap subassembly is next assembled onto a friction rod with a spring coaxially surrounding the friction rod, having one end abutting the housing and the other end abutting a base at the lower end of the friction rod.

### CROSS-REFERENCE TO RELATED APPLICATIONS

This application claims priority under 35 U.S.C. § 119(e) and the benefit of U.S. Provisional Application No. 61/779,677 entitled NON-CYLINDRICAL DAMPING ELEMENT SUSPENSION, filed on Mar. 13, 2013, by Tyler S. Hernden et al., the entire disclosure of which is incorporated herein by reference.

### BACKGROUND OF THE INVENTION

The present invention relates to a damper that contains one or more non-cylindrical friction damping elements engaging the outside surface of a friction rod element.

Dampers are employed in a variety of applications for preventing excessive, uncontrolled movement. In one application, for example, in horizontal or vertical axis washing machines, designed dampers are employed to prevent the washer basket from over-vibration during a spin cycle. U.S. Publication No. 2003/0183994 entitled DAMPER SPRING STRUT discloses the environment of such an application for a damper. U.S. Pat. No. 7,549,519 discloses another damper used in this environment.

A single sheet of cylindrical foam, typically used in prior art dampers, is relatively large, expensive to manufacture, difficult to grease, as well as difficult to assemble into an elongated annular cavity of a housing for the foam. The sheet of foam must be injected with grease in order for the damper to provide damping over extended cycling. The foam and grease are susceptible to water, chemical, and foreign matter contamination because the housing typically must have a relatively large hole necessary for inserting the foam into the housing.

There remains a need, therefore, for a damper which can be constructed in alternate geometries with a flat sheet or multiple flat sheets of foam in a non-cylindrical geometry where the foam is smaller and in pad form, which is more economical to manufacture, easier to inject with grease, better able to retain grease, better able to shed water and contaminants, and better able to provide damping over an extended lifetime of cycling.

### SUMMARY OF THE INVENTION

The system of the present invention satisfies this need by providing one or more sheets or pads of foam that are mounted in recessed housings that are slideably mounted on a friction rod of a damper.

The present invention further provides a spring and damping system which is relatively inexpensive and easily assembled.

The present invention further retains the grease in and around the foam element better since the dimensions of the hole at the top of the housing are only slightly larger than the friction rod dimensions and thus better able to retain grease on the foam.

The present invention also repels water from the foam better since the hole dimensions at the top of the housing are only slightly larger than the rod dimensions and better prevent water from contacting the foam.

A suspension friction rod damper assembly includes a housing defining a cavity including a wall having a recess for receiving at least one planar compressible friction element that can be formed to conform to the shape of the cavity wall and engage a friction rod when the housing is installed on the friction rod of the damper.

In one preferred embodiment, the friction element comprises a sheet of foam that is cut into multiple rectangular pads. The foam is then injected with grease. Two rectangular greased foam pads are then inserted into a circular recess of an open housing. A cap is then assembled onto the housing. The housing-foam-cap subassembly is next assembled onto a friction rod. A spring is arranged coaxially around the friction rod, having one end abutting the housing and the other end abutting a base of the lower end of the friction rod. This embodiment is disclosed in FIGS. 2-3 and 16-17.

In an alternate embodiment, the friction element comprises a foam sheet that is cut into multiple rectangular pads and injected with grease. Two greased foam pads are then inserted in two semicircular recesses in an open housing. A cap is assembled onto the housing. The housing-foam-cap subassembly is then assembled onto a friction rod. A spring is arranged coaxially around the friction rod, having one end abutting the housing and the other end abutting a base at the lower end of the friction rod. This embodiment is disclosed in FIGS. 2-3 and 18-19.

In yet another embodiment, the friction element comprises a foam sheet that is cut into multiple rectangular pads, injected with grease, and inserted into two open holders each with an approximately half-cylinder shape. The half-cylinder holders are assembled together and inserted into a housing with an annular inner cavity. A cap is then assembled onto the housing. The holder-housing-foam-cap subassembly is then assembled onto a friction rod. A spring is arranged coaxially around the rod, having one end abutting the housing and the other end abutting a base at the lower end of the rod. This embodiment is disclosed in FIGS. 4-5 and 8-14.

In yet another alternate embodiment, the friction element comprises a foam sheet that is cut into multiple rectangular pads, injected with grease, and inserted into an open housing with a clamshell design that includes an integral hinge. The clamshell housing is closed into an annular housing form, the housing is fixed shut, with a cap is assembled onto the housing. The housing-foam-cap subassembly is then assembled onto a friction rod. A spring is arranged coaxially around the friction rod, having one end abutting the housing and the other end abutting a base at the lower end of the friction rod. This embodiment is disclosed in FIGS. 6-7 and 15.

With such damper designs, a compact, relatively inexpensive, durable damper is provided which can be configured to provide varying levels of damping force.

These and other features, objects and advantages of the present invention will become apparent upon reading the following description thereof together with reference to the accompanying drawings.

### BRIEF DESCRIPTION OF THE DRAWINGS

FIG. 1 is a perspective view of a washing machine, shown partly broken away to illustrate the mounting of two of the dampers embodying the present invention;

FIG. 2 is a fragmentary vertical cross-sectional view of a damper embodying the present invention shown in FIG. 1, taken along section lines II-II of FIG. 1;

FIG. 3 is a cross-sectional view of the damper shown in FIG. 2, taken along section lines III-III of FIG. 2;

FIG. 4 is a fragmentary vertical cross-sectional view of an alternate embodiment of a damper of the present invention shown in FIG. 1;

FIG. 5 is a cross-sectional view of the damper shown in FIG. 4, taken along section lines V-V of FIG. 4;

FIG. 6 is a fragmentary vertical cross-sectional view of yet another alternate embodiment a damper of the present invention shown in FIG. 1;

FIG. 7 is a cross-sectional view of the damper shown in FIG. 6, taken along section lines VII-VII of FIG. 6.

FIG. 8 is a front elevational view of a friction element shown in FIG. 2;

FIG. 9 is a side elevational view of the friction element shown in FIG. 8;

FIG. 10 is a perspective view of a housing with a concave recess for receiving the friction element of FIGS. 8 and 9;

FIG. 11 is an perspective view of a housing with a flat recess for receiving the friction element;

FIG. 12 is a perspective view of a housing with a combination flat and concave recess for the friction element;

FIG. 13 is a front elevational view of a housing with a concave recess, as shown in FIG. 5;

FIG. 14 is a cross-sectional view of the housing of FIG. 13, taken along section lines XIV-XIV of FIG. 13;

FIG. 15 is a side elevational view of an alternative single-piece clamshell housing;

FIG. 16 is a perspective view of the single-piece housing of FIG. 15, showing the annular recess;

FIG. 17 is a perspective view of the assembled alternative single-piece housing with an annular recess and two non-cylindrical friction elements installed;

FIG. 18 is a perspective view of an alternative single-piece housing with semicircular recesses; and

FIG. 19 is a perspective view of the assembled single-piece housing of FIG. 18 with two non-cylindrical friction elements installed.

### DETAILED DESCRIPTION OF THE PREFERRED EMBODIMENT

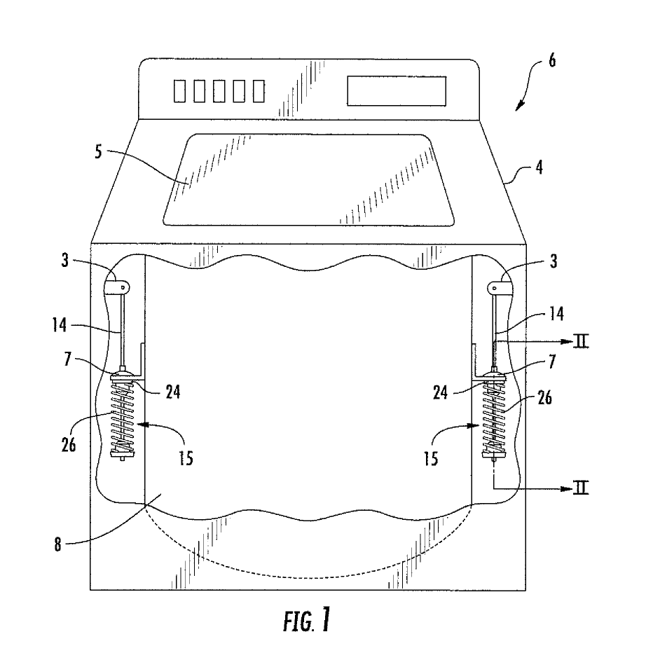

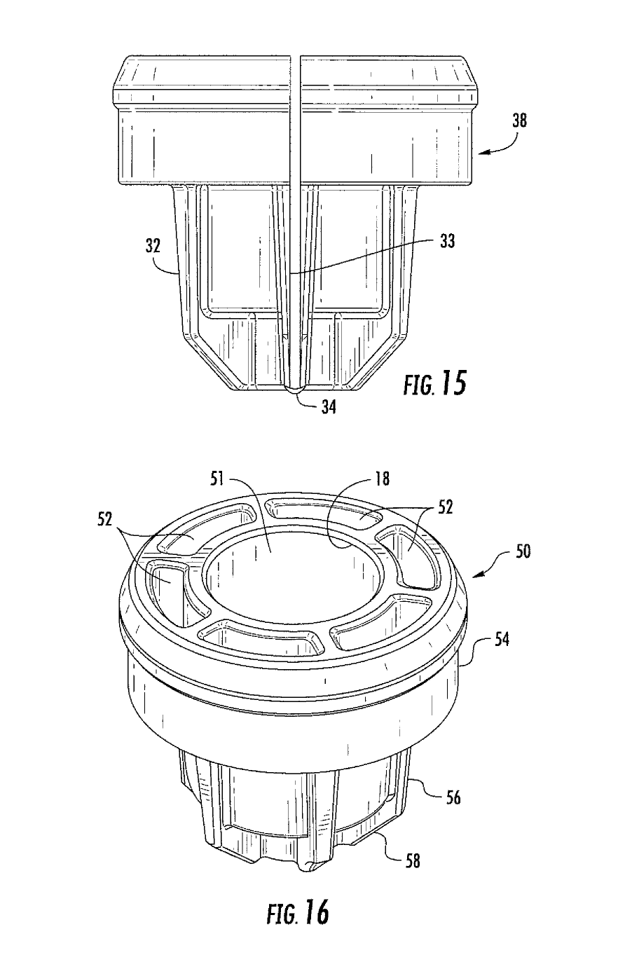

Referring initially to FIG. 1, there is shown a washing machine 6, which includes a cabinet and frame 4 and a drum 8 for receiving clothes to be laundered through a hinged cover 5. Drum 8 rotates and agitates the clothes during wash and spin dry cycles and is subject to vibrations during normal operation of the machine, particularly when there are unbalanced loads. Drum 8 is supported by a plurality of dampers 15 (two shown in FIG. 1) at various locations. The dampers are mounted in a tension mode and movably held by a hemispherical bracket 7 secured to the drum 8. The hemispherical upper surface of the end cap 24 of damper 15 nests within the hemispherical socket of bracket 7 to allow the dampers 15, 20, or 40 (shown in FIGS. 2-7) to move with the movement of drum 8 with respect to cabinet frame 4. Each of the dampers includes a friction rod 14 extending therefrom with the upper end of rod 14 secured to the frame 4 of the machine by a bracket 3. Typically, four such dampers are employed for suspending the drum 8 within cabinet 4 and provide the desired improved damping function of this invention. The various embodiments of the dampers 15 are described in detail in connection with FIGS. 2-19.

Although FIG. 1 illustrates one application of a suspension friction rod damper assembly of the present invention, one or more of the dampers 15 can be mounted in a variety of manners between a fixed and a movable element, the motion of which is to be damped as, for example, shown in U.S. Patent Publication No. 2003/0183994, the disclosure of which is incorporated herein by reference.

Each of the dampers 15, 20, and 40 used in the environment of FIG. 1 and embodying this invention include a housing assembly 16, 25, and 41 (FIGS. 2, 4, and 6 respectively). A central friction rod 14 has a lower flared end 19 securing the end of rod 14 to the lower side of a washer 28 in each of the embodiments. The rod then extends upwardly through an aperture in a polymeric base 27, coaxially within a compression spring 26, and then through apertures in one of the housing assemblies 16, 25, or 41, respectively. Each housing assembly 16, 25, and 41 includes a polymeric hemispherical housing cap 24 and a polymeric generally spool-shaped housing 23, 32, and 38, respectively, with a central recess 18 (FIGS. 2-7, 16 and 19) through which the friction rod 14 extends surrounded by one of the friction elements disclosed. The frictional elements in the preferred embodiment are generally rectangular foam pads 21 (FIGS. 8-9) and are made of a high density polyurethane foam. Frictional elements 21 may take on other geometric planar shapes, such as square, depending on the housing geometry and the frictional effect desired. The frictional elements of the subject invention are cut from a sheet of foam of about 3-7 mm thickness, and preferably 5 mm, to define the friction elements 21. The foam density is from about 2-50 Kg/m3. About 1 to about 5 cc of damping grease 17 (FIGS. 8 and 9) is injected into the foam pads 21 in a conventional manner. A compression spring 26 extends between the lower end or shoulder 12 of housing 23 and the upper side of a base 27 (FIG. 2). A washer 28 is positioned between a flared or coined end 19 on the lower end of friction rod 14 and the base 27 (FIG. 2). During assembly of any one of the housing assemblies 16, 25, or 41, the foam pads 21 can be injected with grease 17 at one or several stages:
i. before the foam elements 21 are placed in any of the alternate housings 23 or 32; or
ii. after the foam elements 21 are placed in any of the alternate housings 23 or 32.

FIGS. 3, 5, and 7 are depicted as “complete” sections for clarity, as if the dampers of FIGS. 2, 4, and 6 were not sectioned. That is, FIGS. 3, 5 and 7 technically should just be 180° sectors instead of 360° sectors. FIG. 3 is a section view of the preferred embodiment shown in FIG. 2, showing housing 23, cap 24, foam pads 21, and central friction rod 14, taken along section lines III-III of FIG. 2.

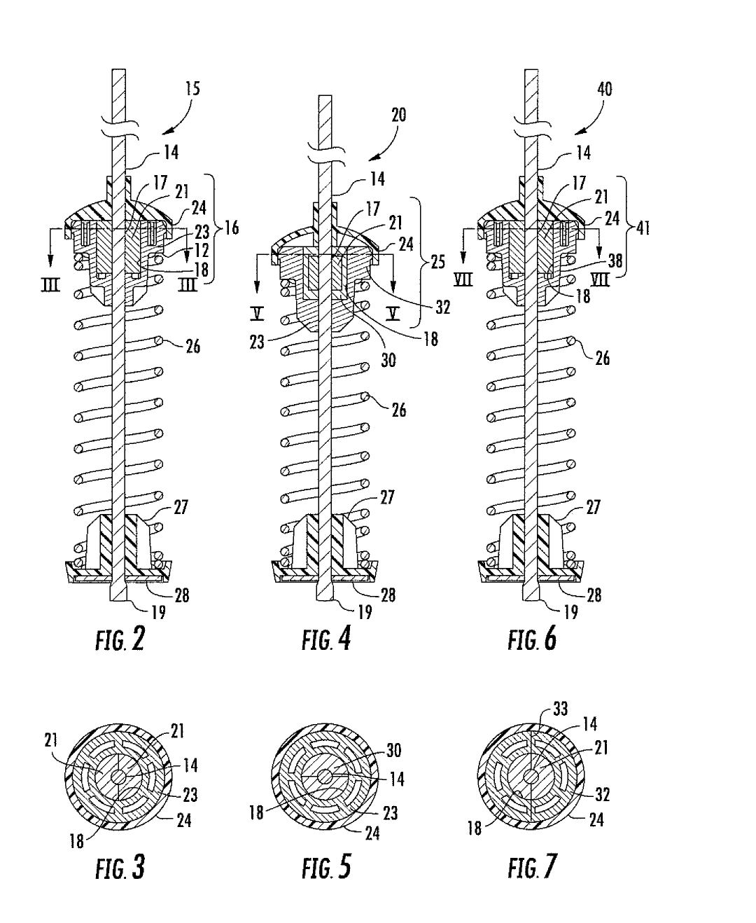

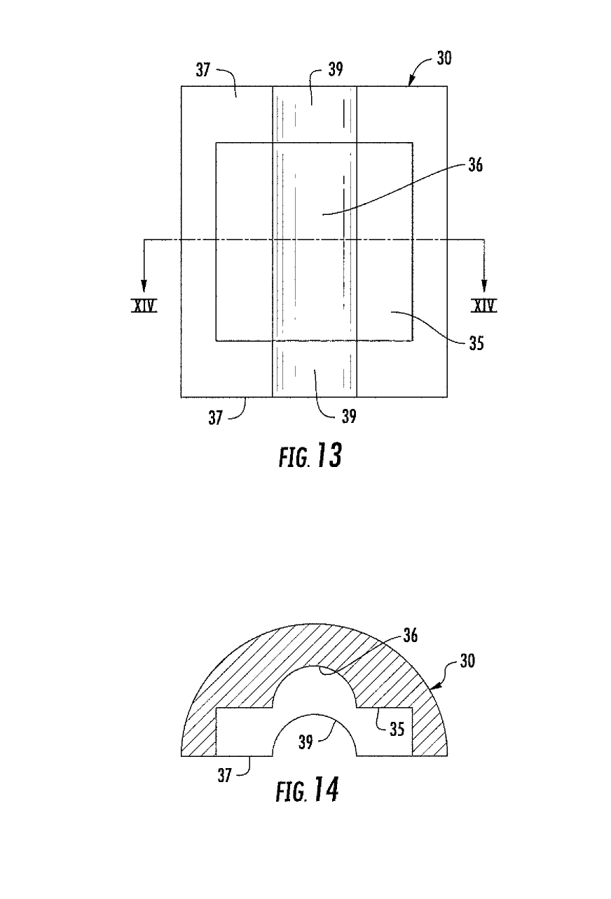

FIGS. 4 and 5 show an alternate embodiment damper 20 that includes a housing assembly 25 and a central friction rod 14 extending therefrom (FIGS. 4 and 5). The housing assembly 25 includes a polymeric spherical housing cap 24, a polymeric spool-shaped housing 23 with a central recess 18. Two rectangular pads of friction element damping foam 21, with about 1 to about 5 cc of damping grease 17 (FIGS. 4, 5, 8, and 9) is injected into the foam 21. Two polymeric foam holders 30 (FIGS. 10-14) are employed in the embodiment of FIGS. 4 and 5 and fit within the recess 18 of housing 23. The holders 30 have a central concave recess 31 (FIG. 10) for receiving the foam pads 21. A compression spring 26 extends between the housing assembly 25 and a base 27 (FIG. 4). A washer 28 sits between the coined end 19 on the bottom end of friction rod 14 and the base 27 (FIG. 4).

The polymeric foam holders 30 may be of different geometries, including employing flat recess 35 (FIG. 11). Alternatively, the holder 30 may have a combination flat 35 and concave back 36, as seen in FIGS. 12-14. During assembly of the holders 30 and housing assembly 25, the foam pads 21 can be injected with grease 17 at one or several stages as noted above. The use of preassembled holders and pads facilitate the final assembly of the damper 20 since the pads 21 are preassembled. The holders 30 have upper and lower walls 37 which include recesses 39 that define, when assembled, apertures that closely surround friction rod 14 to repel contaminants from entering the friction element section of the dampers.

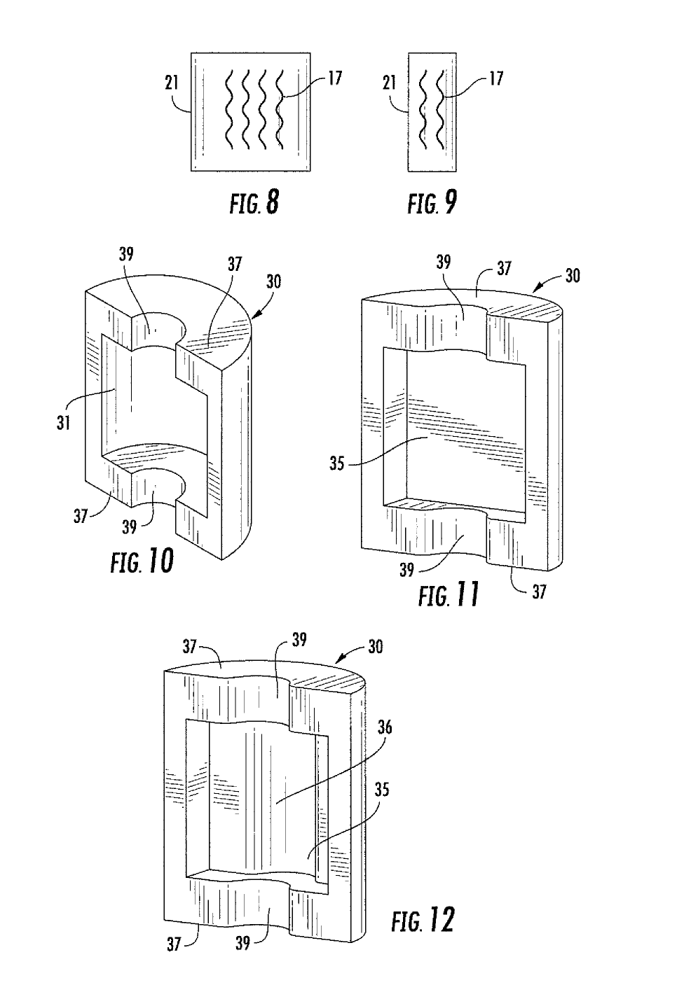

FIGS. 6 and 7 show yet another alternate embodiment damper 40 that includes a housing assembly 41, a one-piece polymeric clamshell housing 32 that is folded on an integral hinge 34 (FIG. 15) to close gap 33 (FIG. 7) that is capped by the polymeric spherical housing cap 24 and that captures foam pads 21 and the central friction rod 14 surrounding the outer surface of the friction rod 14.

FIGS. 16 and 17 show a universal housing 23 which can be used with any of the embodiments from FIGS. 2-7 or alternative embodiments. The housing 23 includes a central recess 18 for receiving friction elements, such as friction elements 21, as illustrated in FIG. 17. The housing can be injection molded of a suitable polymeric material in a single piece and include axially extending relief apertures 52 to minimize material costs and provide some flexibility to the interface between the friction elements 21 and the friction rod 14 when installed. The upper end of the housing defines a collar 54 with inward downwardly extending projection 56 having a lower end 58 which, as noted below, forms a contact surface with the base 27 when the damper is fully extending and spring 26 fully compressed. The recess 18 defines a cavity 51 into which the friction elements comprising foam pads 21 are inserted, as seen in FIG. 17, in tightly compacted relationship while providing an aperture 62 for the passage of the friction rod 14. Housing 23 is held in place on the friction rod within the hemispherical cap 24 in each of the embodiments.

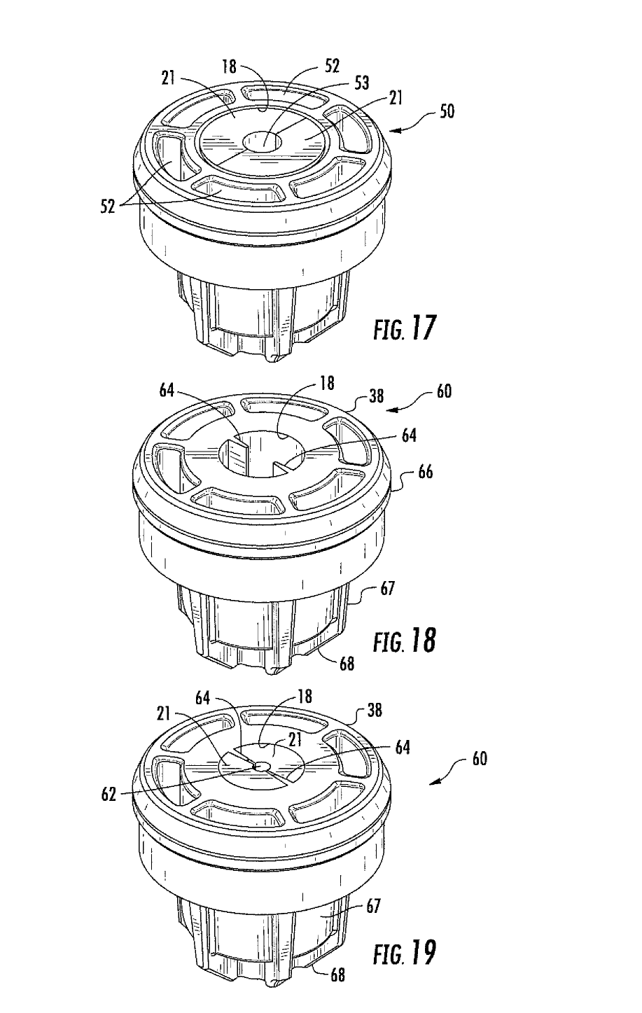

FIGS. 18 and 19 illustrate yet a further embodiment of a housing 60 which is similar in geometry to housing 23 but includes radially inwardly extending dividers 64 aligned at 180° intervals for separating a pair of friction elements 21, as seen in FIG. 19. Again, the foam elements, when inserted into this or other housings or the holders 30, assume a semi-cylindrical shape and include a central aperture 62 to allow the friction rod 14 to extend therethrough. The dividers 64 can vary in thickness (i.e., the width at their intersection with the collar 66 defining the upper end of housing 60) to vary the frictional effect the friction elements 21 have against the friction rod 14. Housing 60 likewise is integrally molded of a polymeric material and includes a downwardly extending section 67 with a lower surface 68 which can interact with the base 27 of the dampers 15, 20, and 40 to control the compression of springs 26.

During operation of the washing machine 6, the housing assembly 16 or any of the alternate housing assemblies 25 or 41 can move up and down the friction rod 14, under the frictional control of frictional elements 21, and in a downward direction until the lower edge of the housing 23 or 32 contacts the upper edge of the base 27. This limited movement protects the spring 26 from over compression.

It will become apparent to those skilled in the art that various modifications to the preferred embodiments of the invention as described herein can be made without departing from the spirit or scope of the invention as defined by the appended claims.

1. A suspension friction rod damper assembly comprising:
a friction rod having an upper end adapted to be coupled to a stationary support structure and having a lower end;
a base mounted to said lower end of said friction rod;
a spool-shaped housing including a wall adapted to be disposed about the friction rod above the base, said wall defining an elongated cavity about the friction rod and having an open top end; and
one or more compressible friction elements positioned inside said cavity and engaging said friction rod.

2. The suspension friction rod assembly as defined in claim 1 wherein said friction element comprises a closed-cell polymeric foam pad.

3. The suspension friction rod assembly as defined in claim 1 wherein there are two compressible friction elements.

4. The suspension friction rod assembly as defined in claim 3 wherein there are two non-semicircular friction elements positioned in said cavity to assume a semicircular shape.

5. The suspension friction rod assembly as defined in claim 1 and including a spring surrounding said friction rod and extending between said base and housing.

6. A suspension friction rod assembly comprising:
a friction rod having an upper end adapted to engage a stationary support structure and having a lower end;
a base mounted to said lower end of said friction rod;
a spool-shaped housing including a wall adapted to surround said friction rod above said base, said wall defining an elongated cavity having an open top end;
at least one divider integrally extending from said wall radially toward said friction rod, said divider defining at least one curved recess about said friction rod; and
at least one compressible friction element that fits inside the curved recess and engaging said friction rod element.

7. The suspension friction rod assembly as defined in claim 6 and further including a pair of dividers extending from said wall radially toward said friction rod at 180° spacing to divide said cavity into two curved recesses and a friction element positioned in each recess for engaging said friction rod.

8. The suspension friction rod assembly as defined in claim 6 wherein said friction element comprises a closed-cell polymeric foam pad.

9. The suspension friction rod assembly as defined in claim 6 including two compressible friction elements.

10. The suspension friction rod assembly as defined in claim 9 wherein said compressible friction elements are assembled in said cavity in a semicircular shape.

11. A suspension friction rod assembly comprising:
a friction rod having an upper end for engaging a stationary support structure and having a lower end;
a base mounted to said lower end of said friction rod;
a spool-shaped cup including a wall disposed in spaced relationship about said friction rod above said base, said wall defining a cavity about the friction rod, said cavity having an open top end;
a holder that fits inside said cavity, said holder defining a recess; and
at least one compressible friction element that fits inside said recess in said holder for engaging the friction rod.

12. The suspension friction rod assembly as defined in claim 11 wherein said recess of said holder has a concave surface.

13. The suspension friction rod assembly as defined in claim 11 wherein said recess of said holder has a flat surface.

14. The suspension friction rod assembly as defined in claim 11 wherein said recess of said holder has flat and concave surfaces.

15. The suspension friction rod assembly as defined in claim 11 wherein said friction element comprises a closed-cell foam polymeric pad.

16. The suspension friction rod assembly as defined in claim 11, wherein said cavity includes a pair of curved holders, each including a compressible friction element.

17. The suspension friction rod assembly as defined in claim 16 wherein said friction elements are positioned in said holders in a semicircular shape.

18. The suspension friction rod assembly as defined claim 11 wherein said at least one holder includes a liquid-shedding upper end.

19. A suspension friction rod assembly comprising:
a friction rod having an upper end for engaging a stationary support structure and having a lower end;
a base mounted to said lower end of said friction rod;
a split housing hinged together and including a wall disposed about said friction rod above said base, said wall defining an elongated cavity about said friction rod having an open top end; and
at least one compressible friction element that fits inside said cavity and engages said friction rod element.

20. The suspension friction rod assembly as defined in claim 19 wherein said friction element comprises a closed-cell foam polymeric pad.

21. The suspension friction rod assembly as defined in claim 19 including two compressible friction elements.

22. The suspension friction rod assembly as defined in claim 21 wherein said compressible friction elements are planar and assume a semicircular shape when positioned in said cavity.

23. A suspension friction rod damper assembly comprising a housing defining a cavity including a wall having a recess for receiving at least one planar compressible friction element that can be formed to conform to the shape of the cavity wall and engage a friction rod when the housing is installed on a friction rod of the damper.

24. A suspension friction rod damper assembly as defined in claim 23 wherein said friction element comprises a foam pad.

25. A suspension friction rod damper assembly as defined in claim 24 wherein said foam pad is made of polyurethane having a thickness of from about 3 to about 7 mm.
